(19) United States
(12) Patent Application Publication
(10) Pub. No.: US 2010/0118209 A1
(43) Pub. Date: May 13, 2010

(54) SYSTEM AND METHOD FOR POWER SAVING VIA CONTEXT BASED COMMUNICATION

(75) Inventor: Robert Hardacker, Escondido, CA (US)

Correspondence Address: SONY C/O MURABITO, HAO & BARNES LLP, TWO NORTH MARKET STREET, THIRD FLOOR, SAN JOSE, CA, 95113, US

(73) Assignees: SONY CORPORATION, Tokyo (JP); SONY ELECTRONICS, Parkridge, NJ (US)

(21) Appl. No.: 12/268,985

(22) Filed: Nov. 11, 2008

(51) Int. Cl. H04N 5/44

(52) U.S. Cl. 348/734; 348/E05.096

(57) ABSTRACT

A system and method for generating remote control signals to control a device while conserving power. The method includes receiving an input command for communication to the device to be controlled and determining a use context based on the input command. Based on the context determination, communication over an infrared transmitter and a radio frequency transmitter is adjusted for power savings where one transmitter is typically active. The input command may then be sent via the infrared transmitter or the radio frequency transmitter. At the completion of the usage mode, the operational states of the transmitters can be switched.

### FIELD OF THE INVENTION

Embodiments of the present invention are generally related to communication devices and systems such as remote control devices, e.g., for remote controlling electronic devices.

### BACKGROUND OF THE INVENTION

As technology advances, display devices such as televisions are being used for an increasing wide variety of activities beyond displaying video, such as web browsing. Correspondingly, remote control devices advanced and added functionality to support in the increase in viewing activities. Further, remote control devices are being used to consolidate the remote controls for a variety of devices including televisions, DVD players, audio systems, home theater computers, and the like.

In response to the increased demand for additional capabilities, designers of remote control devices are looking beyond traditional infrared (IR) based remote control technology. One such technology used in remote controls to support an increase in features has been radio frequency (RF) based communication. While RF communication can solve the demand for increased capabilities such as bi-directional communication, etc., RF communication unfortunately uses more power than IR communication and thereby reduces battery life. The addition of a battery charger and/or cradle to a remote control is not advantageous because these devices increase the cost of the remote control. For remote controls using disposable batteries, the batteries will have to be changed more often when RF communication is used.

### SUMMARY OF THE INVENTION

Thus, a need exists for a device that can provide remote control and radio frequency (RF) supported functionality while conserving battery life of the remote control device. Embodiments of the present invention provide a remote control device having radio frequency based communication while saving power. More specifically, embodiments selectively use radio frequency and infrared communication within a remote control device in order to extend battery life. The selection can be context driven. Embodiments conserve power thereby further allowing use of higher power radio frequency communication transmitters/receivers which provide better performance by extending the control range.

In one embodiment, the present invention is implemented as a method for generating signals for remote controlling an electronic device (e.g., television, monitor, etc). The method includes receiving an input command for communication to the electronic device and determining a use context based on the input command. Based on the context determination, selective communication over an infrared transmitter and/or a radio frequency transmitter is adjusted for power savings when both transmitters reside within a same remote control device. The input command may then be sent via the infrared transmitter or the radio frequency transmitter. For example, the infrared transmitter may be turned on while the radio frequency transmitter is turned off while not in use. Accordingly, the radio frequency transmitter is selectively used based on the command operations desired by the user thereby saving power.

In another embodiment, the present invention is implemented as a system for providing remote control signals to an electronic device. The system includes a first transmitter and a second transmitter each operable to communicate control signals to an electronic device (e.g., display device, television, computer, and the like). The system further includes a control module for controlling the first transmitter (e.g., RF transmitter) and the second transmitter (e.g., IR transmitter). The control module is operable to determine a context in which the electronic device is being used and based on the context, the control module may turn off the first transmitter or the second transmitter. The control module then facilitates communication with the remaining active transmitter. More specifically, for use contexts that can be supported by IR communication, the RF transmitter is turned off and the IR transmitter is used. For advanced use contexts that require the use of the RF transmitter, it is turned on and used. Power savings result from the RF transmitter not being used during use contexts that can be done with the IR transmitter.

In this manner, embodiments of the present invention implement a way for remote control of a device while saving power. Thus, more advanced functions than provided by a single traditional transmitter (e.g., IR transmitter) can be supported (e.g., bidirectionality, pointing device functionality, high speed transfer etc.) while having increased battery life. Further by saving power, embodiments allow use of RF transmitter/receiver devices having increased speed and range thereby improving the user experience.

In another embodiment, the present invention is implemented as a remote control device. The remote control device includes a radio frequency transmitter operable to communicate control signals to an electronic device (e.g., display device, television, computer, and the like) and an infrared transmitter operable to communicate control signals to the device. The remote control further includes a communication module for controlling the radio frequency transmitter and the infrared transmitter. The control module is operable to determine a use context and based on the context selects the infrared transmitter or the radio frequency transmitter for communications based on power conservation or considerations.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows an exemplary remote control system for providing remote control signals in accordance with one embodiment of the present invention.

FIG. 2 shows an exemplary electronic device operable to be remotely controlled in accordance with one embodiment of the present invention.

FIG. 3 shows an exemplary communication diagram in accordance with one embodiment of the present invention.

FIG. 4 shows a flowchart of a process for controlling an electronic device in accordance with one embodiment of the present invention.

FIG. 5 shows a flowchart of an exemplary communication selection process in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

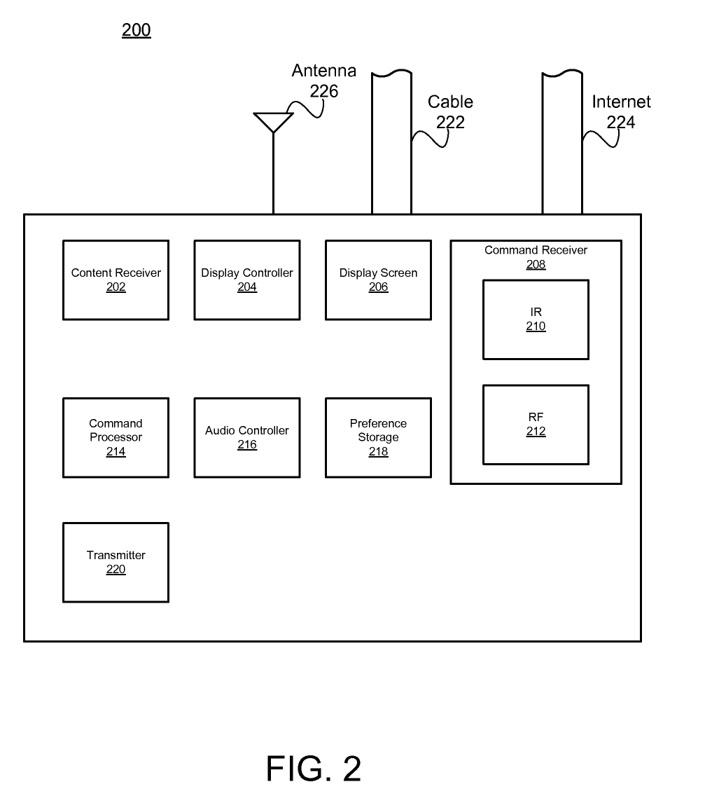

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system (e.g., system 200 of FIG. 2), or similar electronic computing device, that manipulates and transforms data represented as physical (electronic) quantities within the computer system's registers and memories into other data similarly represented as physical quantities within the computer system memories or registers or other such information storage, transmission or display devices.

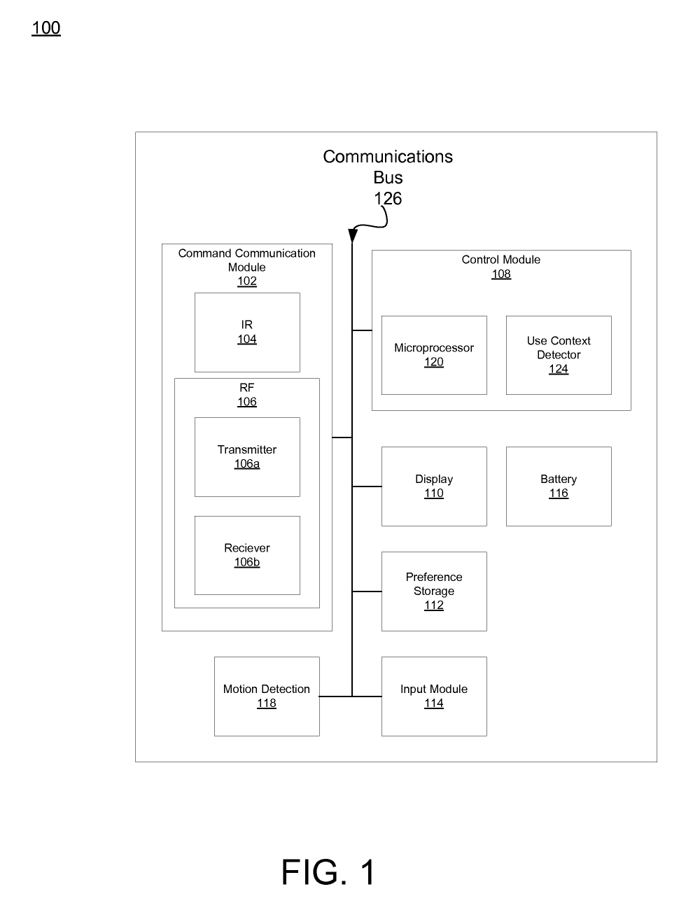

FIG. 1 illustrates example components used by various embodiments of the present invention. Although specific components are disclosed in system 100 it should be appreciated that such components are examples. That is, embodiments of the present invention are well suited to having various other components or variations of the components recited in system 100. It is appreciated that the components in system 100 may operate with other components other than those presented, and that not all of the components of system 100 may be required to achieve the goals of system 100.

FIG. 1 shows an exemplary system for providing remote control in accordance with one embodiment of the present invention. System 100 includes command communication module 102, control module 108, optional display 110, optional preference storage 112, input module 114, power source 116, motion detection module 118, and communication bus 126. Communications bus 126 facilitates communication between the components of system 100 including, but not limited to, command communications module 102, control module 108, display 110, preference storage 112, input module 114, and motion detection module 118. In one embodiment, system 100 may be a hand held remote control device.

Input module 114 allows entry of commands into system 100 which may then be used to control a device (e.g., system 200). Input module 114 may include, but is not limited to, navigations pads, keyboards (e.g., QWERTY), up/down button, touch screen control (e.g., via display 110) and the like.

Command communication module 102 includes a first transmitter operable to communicate control signals to a device (e.g., system 200) and a second transmitter operable to communicate control signals to the device. In one embodiment, command communication module 102 includes IR transmitter 104 and radio frequency (RF) module 106. RF module 106 includes transmitter 106a and optional receiver 106b. Command communication module 102 may further include a radio frequency based receiver which is optional. It is appreciated that command communication module 102 may include a radio frequency transceiver. It is further appreciated that embodiments of the present invention may use a variety of wireless communication formats or protocols including, but not limited to, 802.11a/b/g/n, Bluetooth, Z wave, or other wireless standards or protocols.

It is appreciated that control module 108 may control the first transmitter and the second transmitter. Control module 108 includes microprocessor 120 and use context detector 124. Microprocessor 120 is used to determine use context via use context detector 124 and control command communication module 102. Use context detector 124 determines a context based on user interaction (e.g., key or button presses). Control module 108 is operable to determine a use context of device 100 and based on the use context, turn off the first transmitter or the second transmitter and continuing communication with the remaining active transmitter. The same may be true for the receivers. In one exemplary embodiment, the use context may be based on a button or series of buttons pressed on the remote 200 or based on selections on the device (e.g., on-screen selections).

In one embodiment, one use context is an operating mode having a pointing or cursor mode. Thus, if there is a selection of a command or function making use of device 200 as a pointing device then control module 108 switches over to RF communication. System 100 operating as in a pointing or cursor mode may be facilitated by motion detection module 118. Motion detection module 118 may include multi-axis accelerometers to detect direction, speed, and acceleration which can be translated into position. For example, for regular television viewing, button presses may be sent via IR from device 100 but when web surfing, executing computer applications, interacting with an operating system, navigating an EPG with a cursor or other cursor based navigation commands are received, the IR may be disabled or only selectively used while RF transmitter 106a is active and outputting the directional (e.g., pointing) commands to the device. During this use context, bidirectional RF communication may be enabled.

Power source 116 provides power for system 100. Power source 116 may be portable power source including, but not limited to, batteries, rechargeable batteries (e.g., lithium ion, nickel metal hydride, nickel-cadmium, etc.)

Embodiments of the present invention may facilitate pointing or cursor manipulation (e.g., a remote control being used as a cursor device) via use of accelerometers or gyroscopes. It is appreciated that the nature of radio frequency communication relative to an infrared transmitter may be advantageous for quickly (e.g., high speed) transmitting increased amounts of information associated with accelerometers and gyroscopes. Also, a wider range of remote movement is allowed with RF communication as it is not line of sight, as with IR communication.

The use context may also include keyboard or keystroke commands. For example, control module 108 may switch to RF communication from IR communication for transmitting keystrokes for accuracy and based on the amount of keystrokes.

In one embodiment, control module 108 may switch to communication via RF transmitter 106 for use modes when line of sight is no longer available (e.g., when IR signals can no longer be received by system 200). If this use context is detected, then RF communication may be enabled.

The use context may further include a request to download an electronic programming guide (EPG) to system 100 (e.g., a remote control). RF radio frequency receiver 106b of RF module 106 may be operable to receive an electronic programming guide. For example, system 100 may include a display 110 operable to display an EPG downloaded to system 100. System 100 may then allow a user to browse the EPG while the user is also watching television or another video source. RF communication may be used based on bidirectional communication and speed of transfer. After the EPG has been downloaded to system 100, RF module 106 may be turned off and IR communication restored. The turning off RF module 106 conserves power. RF based receiver 106 may remain off until either the current EPG becomes obsolete (e.g., times listed in the EPG are no longer valid) or the user requests a new EPG (e.g., via an EPG button). Correspondingly, the selection (e.g., music channel, video channel, pay per view, etc.) from the EPG may be transmitted via IR communication.

Preference Storage 112 stores preference information. In one embodiment, user preferences including a pointing device mode preference (e.g., for navigation of an electronic programming guide (EPG)) may be stored in preference storage 112. System 100 may thus turn off IR transmitter 104 and turn on RF module 106 when the use context includes a user preference thereby activating the RF receiver on the device to be controlled (e.g., device 200). In another embodiment, preferences are stored on the device being controlled (e.g., preference storage 118 of system 200), system 100 receives notification of the change in mode. For example, a television could wake up or activate the RF transmitter in a remote control which may be configured to scan for signals that communication should be switched from IR communication (e.g., a low duty cycle circuit). Alternatively, IR communication from device 100 may request the RF section of the system 200 (e.g., RF receiver 212) be enabled, while switching to communication via RF transmitter 106a. Upon receiving the acknowledgement of transmitter 220, IR transmitter 104 may be disabled.

It is appreciated that when one or more of the above described use contexts is determined to be over, embodiments herein disable RF communication and resume IR communication thereby saving power. It is further appreciated that within a use context when RF is enabled, system 100 may till enable IR communication as a second communication pathway.

In one embodiment, system 100 may be a remote control device including a radio frequency (RF) transmitter operable to communicate control signals to a device and an infrared transmitter operable to communicate control signals to a device. The communication module of the remote control device controls communication of the RF transmitter, RF receiver, and the infrared transmitter. System 100 may further include an RF receiver. The communication module is operable to determine a use context and based on the use context selectively use the infrared transmitter or the RF transmitter and/or RF receiver for communication based on power conservation.

The RF transmitter and RF receiver of a remote control may facilitate bidirectional communication (e.g., EPG downloads, secure communication, preference communication). The radio frequency receiver may further facilitate user feedback on the remote control based on on-screen controls, (e.g., vibrations, color changes, etc.) as user moves a pointing device around. Bidirectional communication may also be used when a new device (e.g., DVD player) is installed which announces the presence of the new device presence and tells the remote what settings and configurations to use.

In this fashion, embodiments of the present invention implement a process to provide radio-frequency-based supported functionality while conserving battery life. More specifically, embodiments of the present invention may selectively use radio frequency communication in order to conserve power. For example, relatively lower power IR communication is used for most television commands while RF communication is used for advanced functionality (e.g., high speed, bidirectional communication, and when wide range remote control movement is required). Thus, embodiments of the present invention extend battery life. By reducing overall power consumption, embodiments may further allow use of an increased power RF based receiver and/or transmitter thereby facilitating increase range, speed, and improved payload.

FIG. 2 illustrates exemplary components used by various embodiments of the present invention. Although specific components are disclosed in system 200 it should be appreciated that such components are examples. That is, embodiments of the present invention are well suited to having various other components or variations of the components recited in system 200. It is appreciated that the components in system 200 may operate with other components than other those presented, and that not all of the components of system 200 may be required to achieve the goals of system 200. It is appreciated that embodiments of system 200 include a variety of electronic devices that can be controlled remotely, including but not limited to computers, display devices, televisions, cathode ray tube (CRT) displays, computer monitors, liquid crystal displays (LCDs), plasma displays, projection displays, projectors, portable devices, game consoles, and handheld devices, etc.

FIG. 2 shows an exemplary device operable to be remotely controlled in accordance with one embodiment of the present invention. System 200 includes content receiver 202, display controller 204, display screen 206, command receiver 208, command processor 214, audio controller 216, and preference storage 218, transmitter 220, cable or satellite connection 222, internet connection 224, and wireless antenna 226.

Content receiver 202 receives content for system 200. Receiver 202 may receive signals including content from a variety of sources including, but not limited to, computers, computer networks, portable devices, set top boxes, over the air broadcasts, cable broadcasts, satellite broadcasts, Digital versatile Discs (DVDs), Blu-ray discs, Digital Video Broadcasting-Handheld (DVB-H), Digital Multimedia Broadcasting (DMB), Digital Video Broadcasting Satellite services to Handhelds (DVB-SH), Digital Audio Broadcasting (DAB), Digital Video Broadcasting IP Datacasting (DVB-IPDC), Internet Protocol Television (IPTV), etc. Content receiver 202 may receive content (e.g., electronic programming guide information and other content) via cable or satellite connection 222, internet connection 224, and wireless antenna 226 (e.g., via 802.11a/b/g/n, Bluetooth, Z wave, Digital Broadcast, etc.).

Display controller 204 controls display screen 206 of system 200. Display controller 204 may control a variety of display screens associated with system 200, including but not limited to, CRTs, LCDs, plasma displays, projection based, and Digital Light Processing (DLP) displays.

Command receiver 208 receives commands. Command receiver 208 may receive commands via a variety of receivers including, but not limited to, infrared receiver and radio frequency receivers. The commands may have been issued via a remote control (e.g., system 100 of FIG. 1). In one embodiment, command receiver 208 includes an infrared (IR) receiver 210 and a radio frequency (RF) receiver 212.

Command processor 214 processes commands received by system 200 via command receiver 208. The commands received are processed and executed by system 200. For example, control codes (e.g., increase volume, change channel, launch an application, launch web browser, etc.) may be received by via an infrared receiver 210 or radio frequency receiver 212, decoded, and sent to the command processor 214.

Audio controller 216 controls audio output for system 200 including a variety of outputs including, but not limited to, 2, 2.1, 3.1, 5.1, 6.1, 7.1, and 8.1 channel audio. The audio content may be received via content receiver 202. It is appreciated that audio controller 216 may output to audio equipment integrated within system 200.

Preference Storage 218 may store user preferences. In one embodiment, user preferences including a pointing device mode preference (e.g., for navigation of an electronic programming guide (EPG)) may be stored.

Transmitter 220 may send signals to a control device (e.g., remote control). The signals may include, but are not limited to, acknowledgments, EPGs (e.g., for download to a remote control) encrypted information, and information based on on-screen selections.

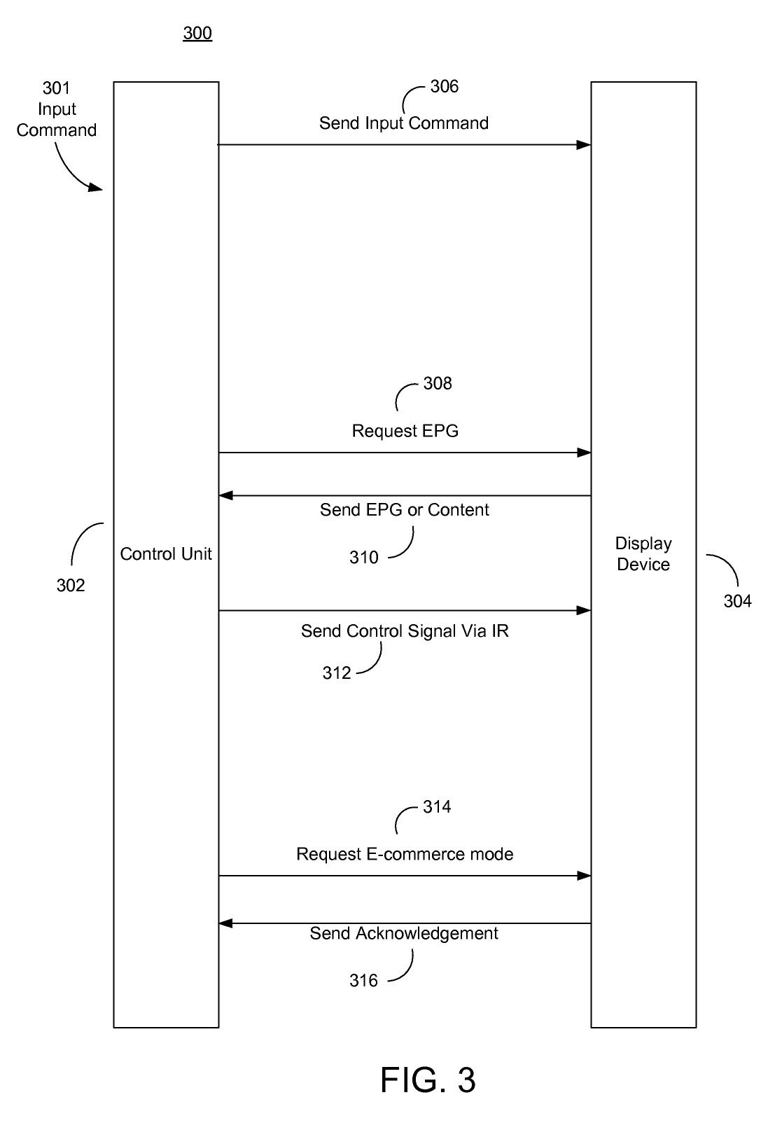

FIG. 3 shows an exemplary communication sequence 300 between a remote control unit 302 (e.g., system 100) and display device 304 (e.g., system 200) in accordance with one embodiment of the present invention. It is appreciated that the communications between control unit 302 and display device 304 may occur via a variety of interfaces including, but not limited to, an infrared transmitter/receiver and a radio frequency (RF) transmitter/receiver, etc.

At step 301, an input command is received by control unit 302. The input command may originate from a button or key press on control unit 302.

At step 306, the input command is sent to display device 402. As described herein, the input command may be sent via infrared unless control unit 302 is in a mode where RF communication is optimal. For example, normal television functions may be sent via infrared while a command of a pointing device mode may be sent via RF communication. At step 306, if IR communication is used, then the RF transmitter is disabled.

At step 308, a request for an electronic programming guide (EPG) is sent by control unit 302 to display device 304. In one embodiment, control unit 302 (e.g., remote control) includes a display (e.g., display 110) operable to display an EPG and facilitate selection of content within the EPG (e.g., via touch screen interaction or button selection). Control unit 302 may send the request for the EPG via an IR interface or an RF interface. If the RF interface is off prior to the request to display device 304, the RF interface may be activated in recognition of an EPG use context that require RF communication.

At step 310, display device 304 sends the EPG or content to control unit 302. In one embodiment, the EPG is sent to control unit 302 via an RF interface because of the speed of transfer and bidirectional nature. After control unit 302 has received the EPG, the RF interface may be deactivated and the IR interface reactivated. Control unit 302 may further receive content for viewing or previewing on control unit 302 (e.g., internet browsing, television transmission viewing, etc.).

At step 312, a control signal with the EPG selection is sent via IR communication. Control unit 302 sends the selection from the EPG via infrared to conserve power.

At step 314, control unit 302 requests to enter an electronic commerce (e-commerce) mode. In one embodiment, the e-commerce mode may be entered via a user pressed button on control unit 302 (e.g., shopping button).

At step 316, display device 304 sends an acknowledgement of the request to enter an e-commerce mode. The acknowledgement may be part of a process to establish and maintain a secure connection between control unit 302 and display device 304 (e.g., handshaking, encryption, verification of trusted devices, etc.). The device 302 recognizes the e-commerce request as a special mode that requires RF communication and enabled the RF transmitter.

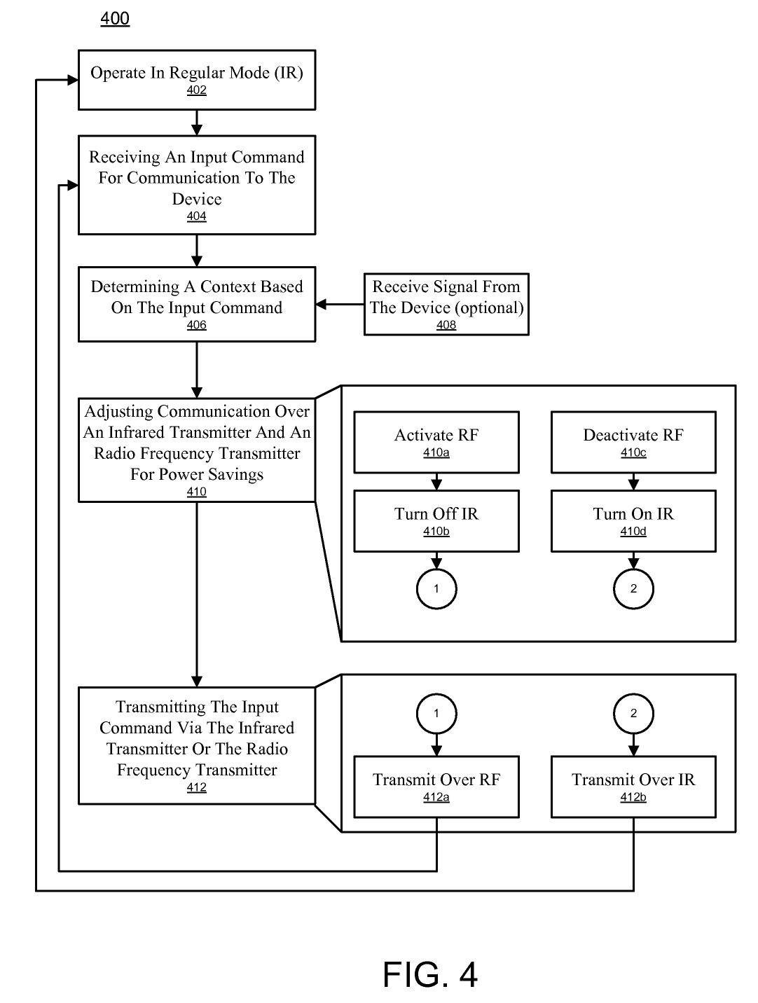

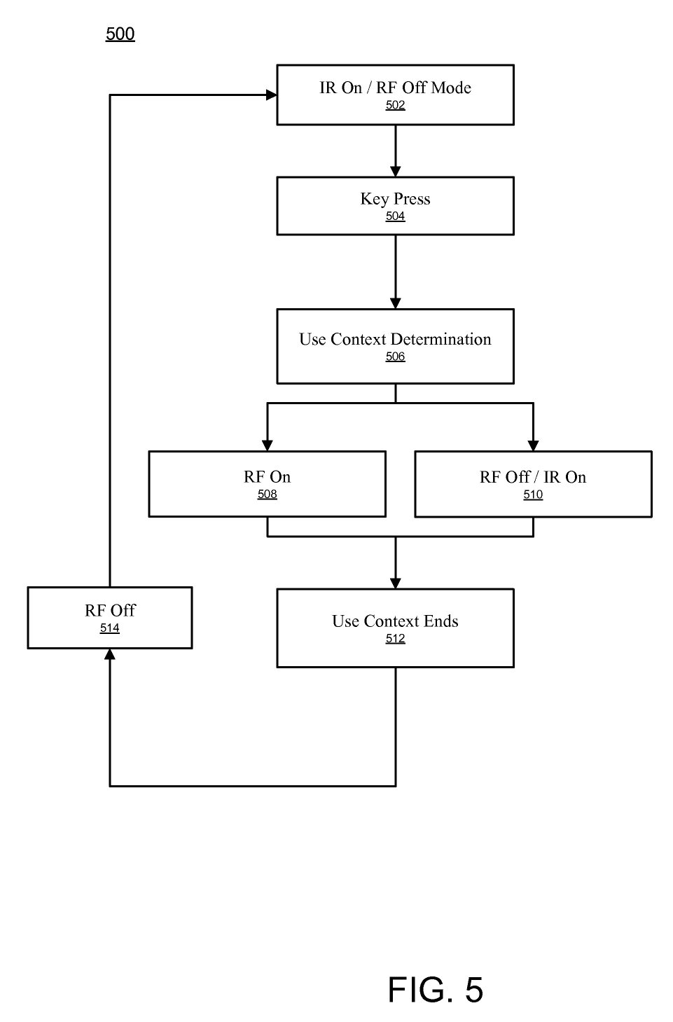

With reference to FIGS. 4 and 5, flowcharts 400 and 500 illustrate example functions used by various embodiments of the present invention. Flowcharts 400 and 500 include processes that, in various embodiments, are carried out by a processor (of FIG. 1) under the control of computer-readable and computer-executable instructions which may be stored on a computer-readable medium. Although specific function blocks (“blocks”) are disclosed in flowcharts 400 and 500, such steps are examples. That is, embodiments are well suited to performing various other blocks or variations of the blocks recited in flowcharts 400 and 500. It is appreciated that the blocks in flowcharts 400 and 500 may be performed in an order different than presented, and that not all of the blocks in flowcharts 400 and 500 may be performed.

FIG. 4 shows a flowchart of a process for controlling a device in accordance with one embodiment of the present invention. The portions of flowchart 400 may be carried out by a remote control unit (e.g. system 100, control unit 302, or remote control).

At block 402, a system (e.g., system 100) operates in a regular mode. In one embodiment, the regular operating mode is a mode where the system communicates (e.g., sends TV control commands) via infrared communication and the RF transmitter is disabled.

At block 404, an input command from a user for communication to a device is received. As described herein, the input command may be a variety of commands including, but not limited to, basic television commands (e.g., volume up/down, channel up/down, menu, input/source selection, etc.), web browsing or internet mode, electronic programming guide (EPG), or keystroke (e.g., from a QWERTY keyboard).

At block 406, a use context is automatically determined based on the input command and a set of recognized functions that are stored by the remote device. As described herein, the use context can include a pointing device mode (e.g., web browsing/surfing, computer or operating system, accelerometers or gyroscope based mode), preference settings, an EPG request, an e-commerce request, or a mode needing a bidirectional communication, or regular television mode. For example, the preference settings could include whether a user navigates an EPG with traditional remote control buttons (e.g., arrow buttons or a navigation pad) or a cursor/pointing style mode. In one embodiment, the preference settings may be stored in a memory accessible by a control unit (e.g., control unit 302 or a remote control). In another embodiment, the preference settings may be stored on the device to be controlled (e.g., display device, television, and the like).

The use context can further include a keyboard mode (e.g., for email composing, uniform resource locator (URL) entry, text messaging, instant messaging). Embodiments of the present invention may have hard keyboards including a full keyboard (e.g., QWERTY keyboard) or could be a soft keyboard (e.g., on screen keyboard on control device with a touch screen display). RF communication may be particularly better suited for transmitting keystrokes for accuracy and the amount of keystrokes. Further, the use of both thumbs for entering data might preclude accurate pointing for an infrared remote control at a receiver in a device.

At optional block 408, a signal is received from a device. The device may be a display device and as described herein, may be indicating a change in the mode. For example, a television could indicate to a remote control via RF communication that a selection has been made to enter a web browsing mode or pointing device mode (e.g., for an EPG based on a stored preference). The signal of 408 can be used to perform the use content determination, in one embodiment.

At block 410 based on the use context determination, communication over an infrared transmitter and a radio frequency transmitter is adjusted for power savings.

At block 410a, the radio frequency transmitter is activated for sending the input command. At block 410b, the infrared transmitter is deactivated in order to save power. For example, when a pointing device mode or other mode where RF communication is optimal is determined, the RF transmitter which was off to conserve power is turned on for the transmission of the input command. It is appreciated that the RF transmitter may remain on as long as input commands that are optimally sent via RF communication are received.

At block 410c the use context is complete and the radio frequency transmitter is deactivated thereby reducing the power used. At block 410d, the infrared transmitter is turned on thereby allowing communication of an input command at less power than via the RF transmitter. For example, if a user has pressed a button to go back to watching TV, the command can be communicated via IR and the RF transmitter can be deactivated to conserve power. It is appreciated that the IR transmitter may remain on while commands that may be sent over IR are received.

At block 412, the input command is transmitted via the infrared transmitter or the radio frequency transmitter. At block 412a, the command is transmitted via RF communication. At block 412b, the command is transmitted via IR communication.

FIG. 5 shows a flowchart of an exemplary communication selection process in accordance with one embodiment of the present invention. The processes of flowchart 500 may be carried out by a remote control unit (e.g. system 100, control unit 302, or remote control).

At block 502, a remote control is in an IR on and RF off mode. In one embodiment, this mode may be a default mode.

At block 504, a key press is received. As described herein, the key press may be from a navigation pad, keyboard, and the like.

At block 506, a use context determination is performed. As described herein, the use context is determined based on the key press and the functionality associated with the key press (e.g., pointing device mode, television control, etc.).

At block 508, an RF communication module is turned on. As described herein, RF communication may be used for a pointing device mode, e-commerce mode, bi-directional mode, and the like.

At block 510, RF communication is turned off and IR communication is turned on. As described herein, IR communications may be used for video remote control features (e.g., volume, channel, display settings, etc.).

At block 512, the use context ends. As described herein, the use context may end when a command is transmitted to a device to be controlled (e.g., system 200).

At block 514, RF communication is turned off when the use context utilizing RF communication is over. RF communication may be turned off to conserve power.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of generating signals for controlling an electronic device comprising:
receiving an input command from a user for communication to said electronic device;
determining a use context based on said input command;
in response to said use context, automatically adjusting communication over an infrared transmitter and a radio frequency transmitter; and
transmitting said input command via one of said infrared transmitter and said radio frequency transmitter to said electronic device.

2. The method of claim 1 wherein said automatically adjusting comprises turning off said radio frequency transmitter.

3. The method of claim 1 wherein said automatically adjusting comprises turning on said radio frequency transmitter.

4. The method of claim 1 wherein said adjusting communication over an infrared transmitter and a radio frequency transmitter reduces power consumption.

5. The method of claim 3 wherein said use context comprises an internet usage mode.

6. The method of claim 3 wherein said use context comprises a pointing device usage mode.

7. The method of claim 3 wherein said use context is determined based on predetermined user preference settings.

8. The method of claim 3 wherein said use context comprises electronic commerce usage.

9. The method of claim 3 wherein said use context comprises a keyboard mode.

10. The method of claim 3 wherein said use context comprises viewing streamed content on a display of a remote control display.

11. A system for performing remote control comprising:
a first transmitter operable to communicate control signals to a device using a first wireless communication;
a second transmitter operable to communicate control signals to said device using a second wireless communication;
a control module for controlling said first transmitter and said second transmitter, wherein said control module is operable to determine a use context of said remote control and based thereon turns on one of said first transmitter and said second transmitter and turns off said other transmitter.

12. A system as described in claim 11 wherein said second transmitter is an infrared based transmitter.

13. A system as described in claim 12 wherein said first transmitter is a radio frequency based transmitter.

14. A system as described in claim 13 further comprising:
a radio frequency based receiver.

15. A system as described in claim 14 wherein said radio frequency based receiver is operable to receive electronic programming guide information.

16. A system as described in claim 15 further comprising:
a display operable to display said electronic programming guide information.

17. A system as described in claim 11 wherein said device is a display device.

18. A remote control device comprising:
a radio frequency transmitter operable to communicate control signals to a device;
a infrared transmitter operable to communicate control signals to said device;
a user input device for receiving command from a user;
a communication module for controlling said radio frequency transmitter and said infrared transmitter, wherein said control module is operable to determine a use context based on said commands and based on said use context, select one of said infrared transmitter and said radio frequency transmitter for communication to said device and deactivating the other transmitter.

19. A remote control device as described in claim 18 wherein said radio frequency transmitter is selected for a use context that requires bidirectional communication.

20. A remote control device as described in claim 18 wherein said radio frequency transmitter is selected for a use context that requires the remote control device to be used as a pointing device.
